(19) United States
(12) Patent Application Publication
(10) Pub. No.: US 2011/0141747 A1
(43) Pub. Date: Jun. 16, 2011

(54) BULB FOR ELECTRIC LAMP

(75) Inventor: Jeff BIAR, Taipei County (TW)

(73) Assignee: DOMINTECH CO., LTD., Wugu Township (TW)

(21) Appl. No.: 12/694,449

(22) Filed: Jan. 27, 2010

(30) Foreign Application Priority Data
Dec. 10, 2009 (TW) 98223175

(51) Int. Cl. F21V 3/00; H01K 1/30

(52) U.S. Cl. 362/311.06; 313/110; 362/311.01

(57) ABSTRACT

A bulb for an electric lamp having a light-emitting element includes a light transmittable shell body for housing the light-emitting element. The light transmittable shell body includes an accommodation for receiving the light-emitting element of the electric lamp, and an inner surface surrounding the accommodation. On the inner surface of the light transmittable shell body a plurality of light-guiding portions are provided for guiding the light emitted from the light-emitting element towards an outside of the light transmittable shell body.

### BACKGROUND OF THE INVENTION

1. Field of the Invention

The present invention relates generally to an electric lamp and more particularly, to a bulb for an electric lamp, which can efficiently guide light out of the electric lamp.

2. Description of the Related Art

Conventional incandescent lamps are generally constructed with a thin tungsten filament and a glass bulb housing the tungsten filament. When an electric current passes through the thin tungsten filament, the filament will be heated to an incandescent state and then give off light, which thereafter will radiate outwardly to an outside of the incandescent lamp through the glass bulb. As known to all, incandescent lamps are widely used in household and commercial lighting. However, it is also known that incandescent lamps have a disadvantage of low energy transformation efficiency and a problem in environment protection because only about 10% of energy will be transformed into light and the rest lose as heat. In the light of this, light emitting diodes (hereinafter referred to as “LEDs”), which consume less power than the tungsten filaments, are used more intensively than ever before as light-emitting elements for lamps.

Nevertheless, the conventional glass bulb housing the light-emitting element, tungsten filament or LED for example, has generally a smooth outer surface and a smooth inner surface. As a result, light reflection and/or scattering will occur when the light emitted from the light-emitting element streams on the inner surface of the bulb, unduly affecting the lighting efficiency.

### SUMMARY OF THE INVENTION

The present invention has been accomplished in view of the above-noted circumstances. It is an object of the present invention to provide a bulb for an electric lamp, which is provided at an inner surface thereof with a light-guiding structure for efficiently guiding light towards an outside of the bulb.

To attain the above object, the present invention provides a bulb for an electric lamp having a light-emitting element, which comprises a light transmittable shell body adapted for housing the light-emitting element. The light transmittable shell body has an accommodation for receiving the light-emitting element of the electric lamp, an inner surface surrounding the accommodation, and a plurality of light-guiding portions provided on the inner surface for guiding the light emitted from the light-emitting element towards an outside of the light transmittable shell body.

Preferably, the light-guiding portion may comprise a light-guiding surface protruding outwardly from the inner surface of the light transmittable shell body for guiding the light emitted from the light-emitting element out of the light transmittable shell body.

Preferably, the light-guiding portion may be a protrusion protruding outwardly from the inner surface of the light transmittable shell body and having a light-guiding surface for guiding the light emitted from the light-emitting element out of the light transmittable shell body.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given herein below and the accompanying drawings which are given by way of illustration only, and thus are not limitative of the present invention, and wherein:

FIG. 1 is a sectional view of an electric lamp equipped with a bulb in accordance with a first preferred embodiment of the present invention, and

FIG. 2 is a sectional view of an electric lamp equipped with a bulb in accordance with a second preferred embodiment of the present invention.

### DETAILED DESCRIPTION OF THE INVENTION

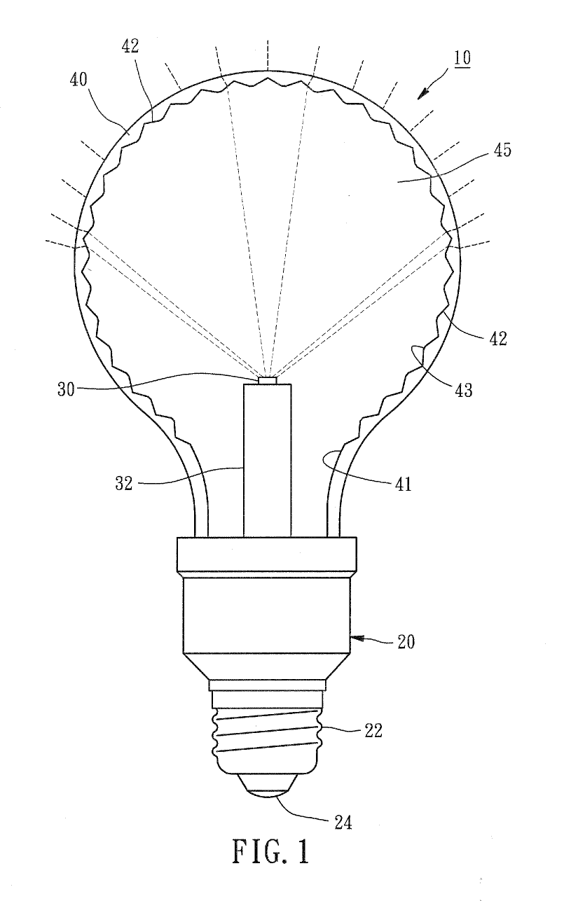

As shown in FIG. 1, the bulb, denoted with reference numeral 40, is served as an element of an electric lamp 10, which comprises an adaptor base 20 and a light-emitting element 30.

The adaptor base 20 of the electric lamp 10 has a threaded conductive portion 22, which is fittable with a general home used electric socket of an incandescent light bulb, and a conductive contact 24 at a bottom thereof.

The light-emitting element 30 is mounted on the top of a support 32 that is fixed on the center of the top of the adapter base 20. In this preferred embodiment, the light-emitting element 30 is realized by using an LED Positive and negative poles (not shown in the drawing) of the LED are respectively electrically connected with the conductive portion 22 and conductive contact 24 of the adapter base 20, such that the light-emitting element 30 will emit light when the adapter base 20 is screwingly inserted into the electric socket and an electric current passes through the light-emitting element 30.

The bulb 40 includes a ball-like shell body made from a light-transmittable material and provided with an accommodation 45, an inner surface 41 surrounding the accommodation 45, and a plurality of light-guiding portions 43 integrally formed and continuously and uniformly arranged on the inner surface 41. In this preferred embodiment, each light-guiding portion 43 is a protrusion integrally and outwardly protruding from the inner surface 41 in such a way that the light-guiding portions 43 each have light-guiding surfaces 41 inclinedly and outwardly protruding form the inner surface 41. As a result, on the inner surface 41 of the bulb 40 a plurality of light-guiding portions shaped like span roofs are uniformly and abuttedly distributed to from a light-guiding structure.

The bulb 40 is mounted on the top of the adaptor base 20 and houses the light-emitting element 30 in such a manner that the light-guiding portions 43 on the inner surface 41 of the bulb are respectively aimed at the light-emitting element 30. As shown in FIG. 1, the light-guiding portions 43 are distributed on the inner surface 41 from the place farthest away from the light-emitting element 30 to the place beneath the light-emitting element 30.

When the electric lamp 10 having the bulb 40 configured in accordance with the first preferred embodiment of the present invention is in use, the light emitted from the light-emitting element 30 will stream on the light-guiding surfaces 42 and then out of the bulb 40 with a shifted light path after refraction resulted from the passing of the light through the light-guiding portions 43. Since the light-guiding portions 43 are abuttedly and uniformly arranged on the inner surface 41, some of the light reflected from one light-guiding surface 42 may pass another, adjacent light-guiding surface 42 and after refraction, stream out of the bulb 40, resulting in that most of the light emitted from the light-emitting element 30 will efficiently stream towards an outside of the bulb 40 randomly and evenly.

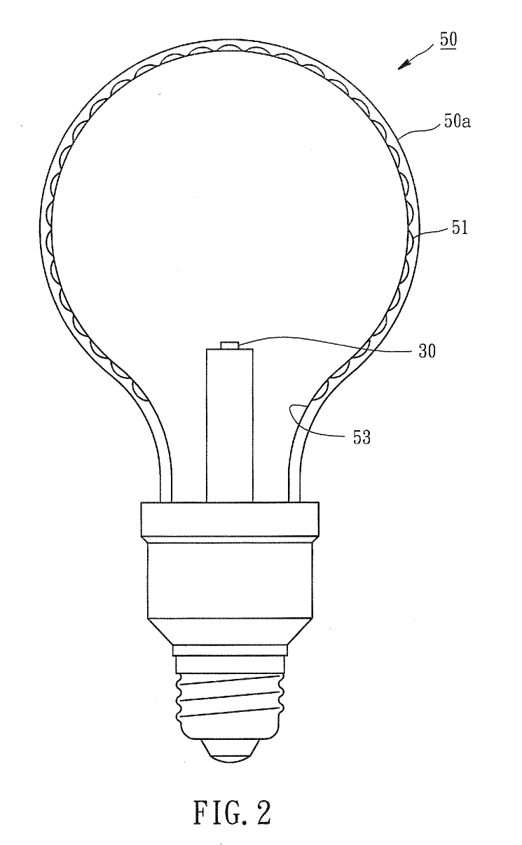

FIG. 2 shows an electric lamp 50 having a bulb 50a configured in accordance with a second preferred embodiment of the present invention. The bulb 50a is provided on an inner surface 53 thereof with a light-guiding structure having a plurality of light-guiding portions, which includes semispherical light-guiding surfaces 51 recessed on the inner surface 53 for guiding most of the light emitted from the light-emitting element 30 towards outside.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A bulb for an electric lamp having a light-emitting element, said bulb comprising:
a light transmittable shell body having an accommodation for receiving the light-emitting element of the electric lamp, an inner surface surrounding the accommodation, and a plurality of light-guiding portions provided on the inner surface for guiding the light that is emitted from the light-emitting element towards an outside of the light transmittable shell body.

2. The bulb as claimed in claim 1, wherein the light-guiding portion comprises a light-guiding surface inclinedly and outwardly protruding from the inner surface of the light transmittable shell body for guiding the light emitted from the light-emitting element towards the outside of the light transmittable shell body.

3. The bulb as claimed in claim 1, wherein the light-guiding portion is a protrusion outwardly protruding from the inner surface of the light transmittable shell body and having a light-guiding surface for guiding the light emitted from the light-emitting element towards the outside of the light transmittable shell body.

4. The bulb as claimed in claim 1, wherein the light-guiding portions are uniformly and continuously arranged on the inner surface of the light transmittable shell body.

5. The bulb as claimed in claim 1, wherein the light-guiding portion comprises a semispherical light-guiding surface recessed on the inner surface of the light transmittable shell body for guiding the light emitted from the light-emitting element towards the outside of the light transmittable shell body.

6. An electric lamp comprising:
an adaptor base;
a light-emitting element mounted on the adaptor base, and
a bulb supported on the adaptor base and housing the light-emitting element, the bulb including a light transmittable shell body having an accommodation for receiving the light-emitting element, an inner surface surrounding the accommodation, and a plurality of light-guiding portions provided on the inner surface for guiding the light that is emitted from the light-emitting element towards an outside of the light transmittable shell body.

7. The electric lamp as claimed in claim 6, wherein the light-guiding portion of the light transmittable shell body comprises a light-guiding surface inclinedly and outwardly protruding from the inner surface of the light transmittable shell body for guiding the light emitted from the light-emitting element towards the outside of the light transmittable shell body.

8. The electric lamp as claimed in claim 6, wherein the light-guiding portion of the light transmittable shell body is a protrusion outwardly protruding from the inner surface of the light transmittable shell body and having a light-guiding surface for guiding the light emitted from the light-emitting element towards the outside of the light transmittable shell body.

9. The electric lamp as claimed in claim 6, wherein the light-guiding portions are uniformly and continuously arranged on the inner surface of the light transmittable shell body.

10. The electric lamp as claimed in claim 6, wherein the light-guiding portion of the light transmittable shell body comprises a semispherical light-guiding surface recessed on the inner surface of the light transmittable shell body for guiding the light emitted from the light-emitting element towards the outside of the light transmittable shell body.
